(19) United States
(12) Patent Application Publication
(10) Pub. No.: US 2007/0255511 A1
(43) Pub. Date: Nov. 1, 2007

(54) General-purpose adaptive reasoning processor and fault-to-failure progression modeling of a multiplicity of regions of degradation for producing remaining useful life estimations

(76) Inventors: James P. Hofmeister, Tucson, AZ (US); Justin B. Judkins, Tucson, AZ (US)

Correspondence Address: HAYES SOLOWAY PC, 175 Canal Street, Manchester, NH, 03101, US

(21) Appl. No.: 11/480,791

(22) Filed: Jul. 3, 2006

Related U.S. Application Data
(60) Provisional application No. 60/795,515, filed on Apr. 28, 2006.

(51) Int. Cl. G06F 19/00; G06F 17/40

(52) U.S. Cl. 702/34; 702/1; 702/33

(57) ABSTRACT

The system contains a device and a defining signature of at least one characteristic of the device. The defining signature changing as the device accumulates damage through a period of useful lifetime in a damaged state. A sensor is in communication with the device. The sensor sensing at least one of the characteristics of the defining signature as the device accumulates damage through the period of useful lifetime. A predictive curve is provided with the defining signature mapped over the anticipated useful lifetime of the device in the damaged state. The predictive curve provides a preliminary prediction of the remaining useful lifetime of the device in the damaged state. A reasoner is in communication with the sensor. The reasoner modifies the predictive curve relative to the sensed defining signature, thereby providing a normalization of the defining signature to the predictive curve.

### CROSS-REFERENCE TO RELATED APPLICATION

This application claims priority to co-pending U.S. Provisional Application entitled, “General-Purpose Adaptive Reasoning Processor and Fault-to-Failure Progression Modeling of a Multiplicity of Regions of Degradation for Producing Remaining Useful Life Estimations,” having Ser. No. 60/795,515 filed Apr. 28, 2006, which is entirely incorporated herein by reference.

### STATEMENT REGARDING FEDERALLY SPONSORED RESEARCH OR DEVELOPMENT

This invention was made in part with Government support under contract number N68335-06-C-0082 awarded by the Naval Air Warfare Center AD (LKE). The Government may have certain rights in the invention.

### FIELD OF THE INVENTION

The present invention is generally related to predictive analytics of device failure and, more particularly, is related to a novel method of accurately predicting device failure for individual devices.

### BACKGROUND OF THE INVENTION

Basic electronic devices, both passive and active, such as capacitors and opto-isolators are subject to accumulative fatigue damage that eventually results in operational failure of the device. The fatigue damage is caused by stresses and strains induced by many mechanisms such as an over-voltage, over-current or over-temperature condition in the normal operating environment of the device. The physics-of-failure of these devices are varied and include crystal-lattice damage, oxide breakdown, junction damage, holes or opens and shorts. Regardless of the exact mechanism of failure, as a device degrades from a state of no damage to a state of damage high enough to deem the device as failed, the degradation of the device often manifests in one or more characteristics: such as an increase in the amplitude of ripple voltage, a change in output voltage or current, or an increase in noise. A fault signature is a collection of one or more such characteristics. As a device degrades, the fault signature often exhibits changes, such as an increase or decrease in the rate of change in amplitude of a particular characteristic measurand, such as voltage. The progression of the changes in signature corresponding from a state of no or little damage to a state of damage resulting in failure of a device is referred to as a “fault-to-failure progression.”

Of interest in a system to manage the maintenance of electronic sub-assemblies, assemblies and systems is the early detection by one or more sensors of a signature that indicates degradation. Typically the degradation signature indicates a fault-to-failure progression as evidenced by increases in magnitude or frequency or periodicity as fatigue damage accumulates.

One such example is the output filter capacitor of a power supply. As the capacitor degrades, leakage current, modeled as an equivalent series resistance (ESR), increases and the amplitude of the ripple voltage on the output increases. When the leakage current becomes very large, for example 1000s of times larger than the base leakage current of the capacitor in an undamaged state, the filtering effectiveness of the capacitor is significantly impaired and is deemed to have failed.

Also of interest in a system of maintenance management is to use identified measurands of failure characteristics, the signature, as the basis for fault-to-failure progression models and reasoners. Reasoners process model parameters, rules and measurands (data) to arrive at a reasoned conclusion as to the state of health of the object that is modeled, with such conclusions being presented in any number of forms to include, for example, a percentage such as seventy-five percent healthy or a remaining useful life (RUL) estimation such as 150 hours. A first reasoning process might be to determine whether the device is damaged, and if so, a second reasoning process might be to determine the extent of the damage and then to estimate a RUL value. RUL estimates can be used in maintenance protocols for timely maintenance to prevent untimely failures in an operational environment, and at the same time, without requiring unnecessary or too early replacement or repair of parts that are damaged, but are still useable.

RUL estimation is frequently performed in manufacturing and is used to evaluate, for example, the effectiveness of a particular process, material and package in a lifetime test. By comparing test lifetimes, predictions and conclusions can be made regarding one versus the other. The tests are either accelerated or highly accelerated: The intent is to reduce test time while maintaining test result validity. The reasoners and models are typically based on any number of mathematical expressions suitable for the test and the physics of failure. For example, there are any number of expressions that are typically used to model the reliability of devices subject to accumulated fatigue damage and the reasoners are commonly known as “model-based reasoners” or the more specific “reliability model-based reasoners” or “statistical model-based reasoners.”

The problem with physics-of-failure-based modeling, reliability-based reasoning, or statistical-based reasoning, as they have been used in the past, is that similar devices are treated as having identical degradation paths. For example, two capacitors, having similar electrical characteristics and similar construction are treated as if they will degrade identically. However, if the two capacitors are exposed to different environments and/or subjected to different applications/activity, the capacitors will degrade differently. Further, reliability statistics cannot be used to accurately determine the likelihood of failure and the time-to-failure of a specific part that has been subjected to prior damage and which is operating in conditions that might or might not be causing additional accumulated damage.

Thus, a need exists in the industry to address the aforementioned deficiencies and inadequacies.

### SUMMARY OF THE INVENTION

Embodiments of the present invention provide a system and method for predicting a remaining useful lifetime of a device and revising that prediction during the lifetime of the device. Briefly described, in architecture, one embodiment of the system, among others, can be implemented as follows. The system contains a device and a defining signature of one or more characteristics of the device. The defining signature includes at least one characteristic of the device. The defining signature changing as the device accumulates damage through a period of useful lifetime in a damaged state. A sensor is in communication with the device. The sensor sensing at least one of the characteristics of the defining signature as the device accumulates damage through the period of useful lifetime. A predictive curve is provided with the defining signature mapped over the anticipated useful lifetime of the device in the damaged state. The predictive curve provides a preliminary prediction of the remaining useful lifetime of the device in the damaged state. A reasoner is in communication with the sensor. The reasoner modifies the predictive curve relative to the sensed defining signature, thereby providing a normalization of the defining signature to the predictive curve. The present invention can also be viewed as providing methods for predicting a remaining useful lifetime of a device and revising the prediction during the lifetime of the device. In this regard, one embodiment of such a method, among others, can be broadly summarized by the following steps: sensing at least one characteristic of a defining signature of said device over time, said defining signature changing as said device accumulates further damage through a useful lifetime in said damaged state; defining an attainable value for the defining signature, whereby the attainable value is indicative of damage to the device; and modifying a predictive curve relative to the sensed signature in conjunction with the sensed signature achieving a value greater than the attainable value, whereby said predictive curve provides a prediction of said remaining useful lifetime of said device in said damaged state.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a line graph mapping physical measurands (V) over time as a characteristic transfer curve that represents a fault-to-failure signature of an entity.

FIG. 2 is a schematic of a power supply output filter capacitor utilizing the system for predicting a remaining useful lifetime of a device and revising the prediction during the lifetime of the device, in accordance with an exemplary embodiment of the present invention.

FIG. 3 is a line graph of a variation of FIG. 1 consisting of straight-line segments.

FIG. 4 is a geometric representation of an early degradation region, as shown in a portion of the line graph of FIG. 3.

FIG. 5 is a geometric representation of a mid-degradation region, as shown in a portion of the line graph of FIG. 3.

FIG. 6 is a geometric representation of a late degradation region, as shown in a portion of the line graph of FIG. 3.

FIG. 7 is a reconstitution of the geometric representations shown in FIG. 4, FIG. 5, and FIG. 6, representing an exemplary fault-to-failure progression characteristic profile.

FIG. 8 is the geometric representation of the early degradation region of FIG. 4, further illustrating exemplary data points.

FIG. 9 is the geometric representation of the early degradation region of FIG. 4 and FIG. 8, wherein the early degradation region is time-shifted to align with one of the exemplary data points illustrated in FIG. 8.

FIG. 10 is the geometric representation of the early degradation region of FIG. 9, further including a curve intersecting another of the exemplary data points illustrated in FIG. 8 and FIG. 9, and further illustrating a weighted average curve not intersecting any exemplary data points.

FIG. 11 is the geometric representation of the early degradation region of FIG. 10, further including a first modified early degradation region resulting from the curve of FIG. 10.

FIG. 12 is the geometric representation of the first modified early degradation region of FIG. 11, further including additional curves based on an additional exemplary data point introduced in FIG. 8.

FIG. 13 is a geometric representation of the first modified early degradation resulting from the curves in region of FIG. 12.

FIG. 14 is a geometric representation of a second modified early degradation region based on one of the curves illustrated in FIG. 7, further including additional curves based on an additional exemplary data point 120.

FIG. 15 shows the geometric representation of the second modified early degradation region of FIG. 14 based on an exemplary data point 120 introduced in FIG. 14.

FIG. 16 shows a combination of the second modified early degradation region, a first modified mid-degradation region, and the late degradation region in conjunction with a curve for the data point introduced in FIG. 14.

FIG. 17 is a flow chart of one instantiation of a general-purpose adaptive reasoning processor of a fault-to-failure progression model with a multiplicity of regions of degradation for producing remaining useful lifetime estimations.

FIG. 18 is a flow chart for the method of synchronizing the degradation regions.

FIG. 19 is a flow chart of the method for adjusting system time to reflect the model time for the adaptive reasoner.

FIG. 20 is a flow chart of the method for adjusting the model time.

### DETAILED DESCRIPTION OF THE INVENTION

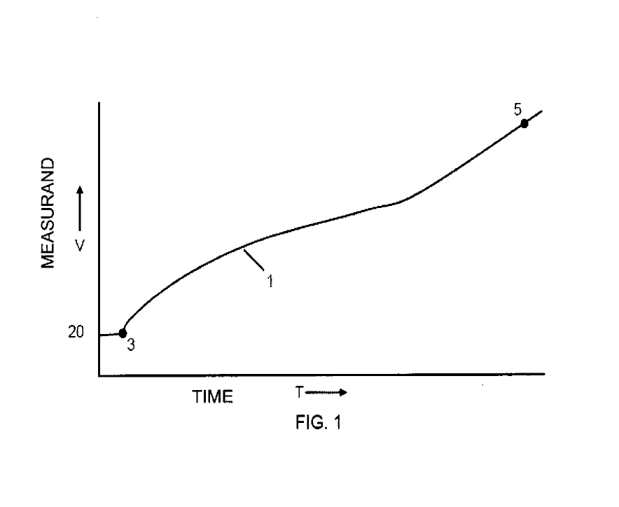

Embodiments of the present invention provide a system for predicting a remaining useful lifetime of a device and revising the prediction during the lifetime of the device. Test-to-fail experiments are conducted and measurements made to produce a characteristic transfer curve that represents a fault-to-failure signature of a device, such as a power supply output filter capacitor. FIG. 1 is an exemplary embodiment of a line graph that may be produced from the test-to-fail experiments. The line graph maps physical measurands (V) over time (T) as a characteristic transfer curve 1 that represents a fault-to-failure signature of the device. An initial threshold point 3 on the characteristic transfer curve 1 is a point at which the curve 1 indicates damage has begun to accumulate. The curve 1 also has a final threshold point 5, above which the device being tested is deemed to have failed.

The device may be any electrical, mechanical, chemical, biological, or other entity that has a finite useful lifetime during a period of time in which the device progresses from a state of no damage to a state of damage sufficient to cause the device to be deemed as having failed. For remaining useful life modeling and estimation, the horizontal axis is specified as a unit of measure of time, although one having ordinary skill in the art will understand that other units of measure may also be appropriately used to map the characteristic transfer curve 1 without deviating from the scope of the invention. The vertical axis is specified as a unit of measure, such as volts for voltage, amperes for current or kilograms for a physical force such as shock. The unit of measure of the vertical axis may be any measurable attribute or quality of the device that alters in value as the device approaches an end of useful life. For instance, as an electrical device fails, resistance on a circuit may change or the circuit may begin generating increasing levels of heat. The unit of measure for the vertical axis is hereinafter referred to as a measurand, a physically measured quantity, property, or condition.

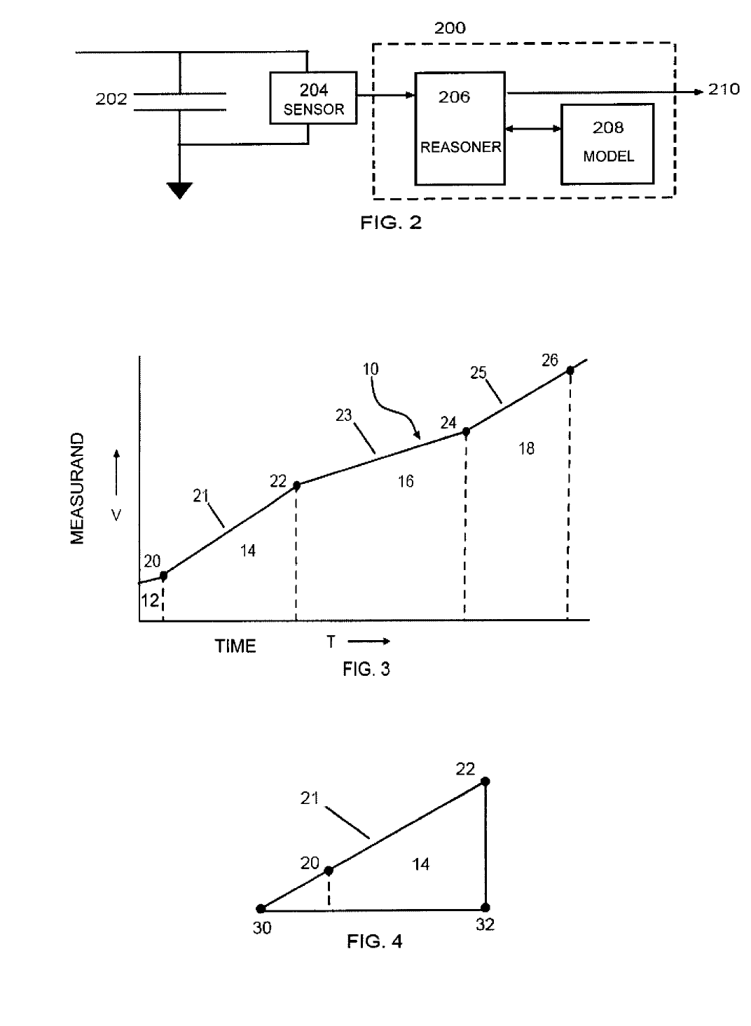

FIG. 2 is a schematic of a power supply output filter capacitor utilizing the system 200 for predicting a remaining useful lifetime of a damaged device 202 and revising the prediction during the lifetime of the device 202, in accordance with an exemplary embodiment of the present invention. A defining signature of the device 202 changes as the device 202 accumulates damage. A sensor 204 is provided in communication with the device 202. The sensor 204 senses one or more characteristics of the defining signature of the device 202 as the device 202 accumulates damage. The characteristic transfer curve 1 is modeled with the defining signature mapped over the anticipated useful lifetime of the device 202 after the device 202 has begun to accumulate damage. The model 208 of the characteristic transfer curve 1 provides a preliminary prediction of the remaining useful lifetime of the device 202 in a state of damage. A reasoner 206 is provided in communication with the sensor 204. The reasoner 206 both reads and writes the model 208 relative to the sensed signature, thereby providing a revised prediction 210 of said remaining useful lifetime of the device 202. The reasoner 206 and the model 208 may simply be an algorithm or a string of code on a processor.

FIG. 3 is a line graph of FIG. 1, consisting of straight-line segments. The line graph of FIG. 1 is fitted and linearized to produce a transfer curve 10 consisting of straight-line segments shown in FIG. 3. The FIG. 1 data is evaluated, linearized and straight-line segments fitted to define a pre-degradation region 12, an early degradation region 14, a mid-degradation region 16, and a late degradation region 18. These degradation regions 12, 14, 16, 18 are defined temporally by when they reach the initial degradation point 20, the second degradation point 22, the third degradation point 24, and the failure point 26. The pre-degradation region 12 is one in which no significant degradation occurs. Moderate degradation occurs in the early degradation region 14, between initial degradation point 20 and the second degradation point 22. Major degradation occurs in the mid-degradation region 16 between the second degradation point 22 and the third degradation point 24. Severe damage occurs in the late degradation region 18, between the third degradation point 24 and the failure point 26. Above the failure point 26, failure occurs.

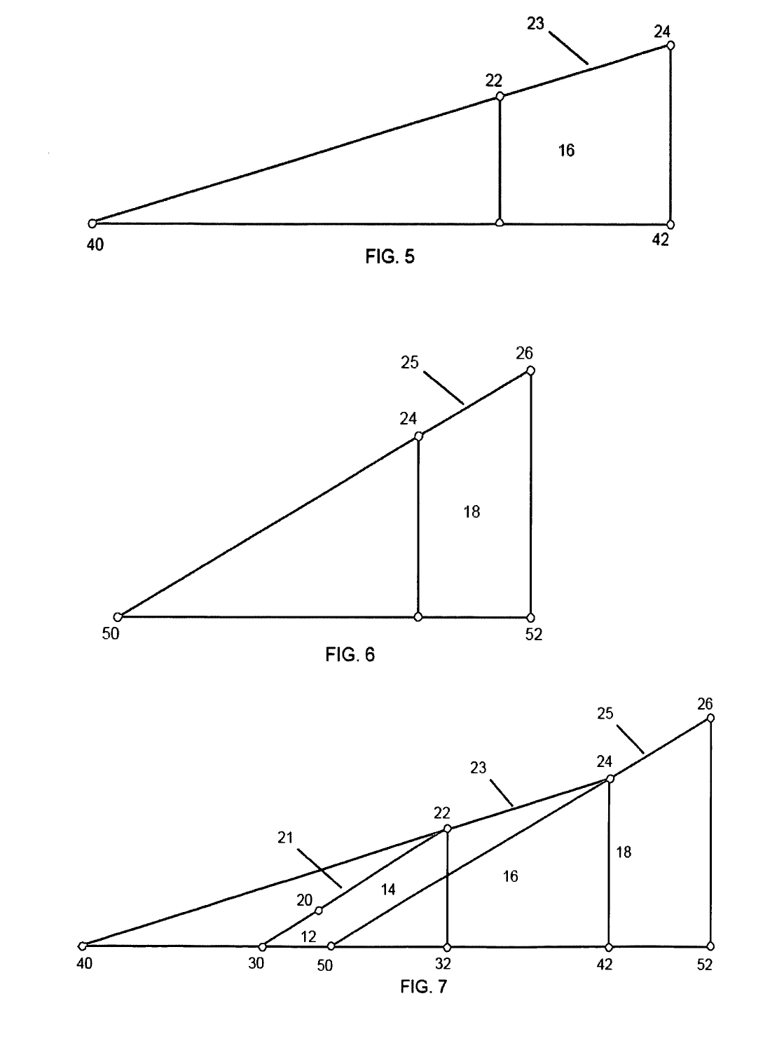

The transfer curve 10 of FIG. 3 can be broken up into any number of a plurality of degradation regions. In this exemplary embodiment, the transfer curve 10 is split into three degradation regions (not including the pre-degradation region 12): the early degradation region 14, the mid-degradation region 16, and the late degradation region 18. Line segments for these degradation regions, including early degradation line segment 21, mid-degradation line segment 23, and late degradation line segment 25, form the transfer curve 10, in part. The degradation regions 14, 16, 18 may be separately modeled as triangles with the slope, m, of the hypotenuse of each triangle representing a rate of degradation such that V (vertical)=m (slope) times T (horizontal). FIG. 4 is a first geometric representation of the early degradation region 14 shown in the line graph of FIG. 3. FIG. 5 is a second geometric representation of the mid-degradation region 16 shown in the line graph of FIG. 3. FIG. 6 is a third geometric representation of the late degradation region 18 shown in the line graph of FIG. 3.

Referring to FIG. 4, the early degradation line segment 21, connecting the initial degradation point 20 and the second degradation point 22, is extended to intersect the horizontal axis at first virtual origin point 30. First virtual origin point 30 becomes the virtual origin (time=0) of the fault-to-failure progression model for the early degradation region 14. The maximum magnitude of the early degradation region 14 is the magnitude at the second degradation point 22 at the time represented by point 32, which is the temporal upper limit of the early degradation region 14.

Referring to FIG. 5, the mid-degradation line segment 23, connecting the second degradation point 22 and the third degradation point 24, is extended to intersect the horizontal axis at second virtual origin point 40. Second virtual origin point 40 becomes the virtual origin (time=0) of the fault-to-failure progression model for the mid-degradation region 16. The maximum magnitude of the mid-degradation region 16 is the magnitude at the third degradation point 24 at the time represented by point 42, which is the temporal upper limit of the mid-degradation region 16.

Referring to FIG. 6, the late degradation line segment 25, connecting the third degradation point 24 and the failure point 26, is extended to intersect the horizontal axis at third virtual origin point 50. Third virtual origin point 50 becomes the virtual origin (time=0) of the fault-to-failure progression model for the late degradation region 18. The maximum magnitude of the late degradation region 18 is the magnitude at the failure point 26 at the time represented by point 52, which is the temporal upper limit of the late degradation region 18.

FIG. 7 is a reconstitution of the geometric representations shown in FIG. 4, FIG. 5, and FIG. 6. The solid-line segments 21, 23, 25 represent the fault-to-failure progression characteristic profile, the signature, of the model. First virtual origin point 30 is the virtual origin of the model. The degradation regions 12, 14, 16, 18 are defined temporally by when they reach the initial degradation point 20, the second degradation point 22, the third degradation point 24, and the failure point 26. The horizontal base, vertical height and slope of the hypotenuse of each triangle defines a region of degradation for the fault-to-failure progression model.

The virtual origin points 30, 40, 50 of the three triangle representations of the three regions of degradation 14, 16, 18 in this model do not coincide in this exemplary embodiment and are generally not expected to coincide. The first virtual origin point 30 is used as the relative time reference point zero (0) of the model and the remaining useful life of the device 202 is the difference of the horizontal axis value of point 52 and the horizontal axis value of the first virtual origin point 30.

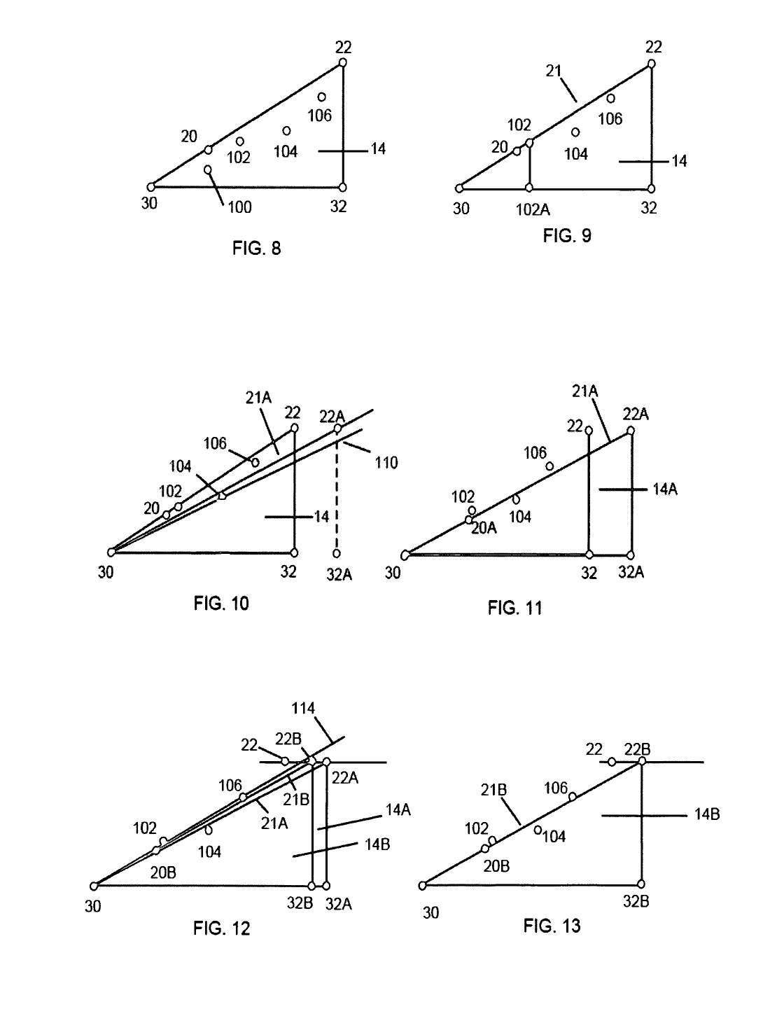

As the sensor 204 detects information with regards to the defining signature of the device 202, that information is communicated to the reasoner 206. The reasoner 206 compares the communicated information to the useful life model. FIG. 8 is the first geographic representation of FIG. 4, further illustrating exemplary data points within the geographic representation. Referring to FIG. 8, assume data points 100, 102, 104 and 106 are coordinates of information received in succession by the reasoner 206 from the sensor 204, wherein the coordinates of information for this exemplary embodiment are a time-stamped measurand. The reasoner 206 discards a first data point 100 because it has a measurand value below the measurand value of the initial degradation point 20. When a second data point 102 is received, the reasoner 206 positions the second data point 102 on the early degradation line segment 21 of the early degradation region 14.

FIG. 9 is the first geographic representation of FIG. 8, wherein the early degradation region 14 is aligned with the second data point 102 illustrated in FIG. 8. Specifically, the model is aligned such that the second data point 102 is along the early degradation line segment 21 of the model. The reasoner 206 uses the measurand magnitude of the second data point 102 and the slope of the early degradation line segment 21 to calculate a value for the first virtual origin point 30 relative to the second data point 102. Time values for all points along the model, which are initially simply relative to the first virtual origin point 30, may now be calculated relative to the value assigned to the first virtual origin point 30. The remaining useful life of the device 202 may now be calculated at the time the second data point 102 is sensed by the sensor 204 as the temporal value of point 52 minus the temporal value of the second data point 102.

FIG. 10 is the first geographic representation of FIG. 9, further including a third data point line 110 intersecting another of the exemplary data points illustrated in FIG. 8 and FIG. 9. Referring to FIG. 10, when the reasoner 206 receives a third data point 104, the slope of the third data point line 110 that passes through the first virtual origin point 30 and the third data point 104 is calculated. The slope of the third data point line 110 is averaged, with or without weighting, with the slope of the early degradation line segment 21 to determine an adapted slope for first modified early degradation line segment 21A, which is then used to adapt the model by changing the model parameters for the region.

FIG. 11 is the first geographic representation of FIG. 10, further including a first modified early degradation region 14A based on the first modified early degradation line segment 21A of FIG. 10. Referring to FIG. 11, the slope of the first modified early degradation line segment 21A is used to determine a first modified second degradation point 22A. The first modified second degradation point 22A maintains a measurand magnitude equal to the second degradation point 22, but adopts a new time coordinate such that the first modified second degradation point 22A is on the first modified early degradation line segment 21A. The first modified early degradation region 14A shifts its upper temporal boundary from point 32 to point 32A, and the first modified early degradation region 14A shifts its initial degradation point from point 20 to point 20A.

The mid-degradation region 16 and the late degradation region 18 are time-shifted so that the upper temporal boundary of the first modified early degradation region 14A coincides with a lower temporal boundary of the mid-degradation region 16. The reasoner 206 then calculates the estimated remaining useful life of the device 202 as the sum of the remaining time in the first modified early degradation region 14A plus the sum of the remaining times in the other regions 16, 18.

FIG. 12 is a first modified early degradation region 14A in FIG. 11, further including additional curves based on a fourth data point 106 introduced in FIG. 8. When the fourth data point 106 is received by the reasoner 206, the reasoner 206 calculates the slope of the fourth data point line 114 passing through the first virtual origin point 30 and the fourth data point 106. The slope of the fourth data point line 114 is averaged, with or without weighting, with slope of the first modified early degradation line segment 21A to determine a second modified early degradation line segment 21B for modifying the first modified early degradation region 14A.

FIG. 13 is a second modified early degradation region 14B based on second modified early degradation line segment 21B illustrated in FIG. 12. The second modified early degradation region 14B is shown in FIG. 13. The second modified second degradation point 22B maintains a measurand magnitude equal to the second degradation point 22, but adopts a new time coordinate such that the second modified second degradation point 22B is on the second modified early degradation line segment 21B. The second modified early degradation region 14B shifts its upper temporal boundary from point 32A to point 32B. The mid-degradation region 16 and the late degradation region 18 are time-shifted so that the upper temporal boundary of the second modified early degradation region 14B coincides with a lower temporal boundary of the mid-degradation region 16. The reasoner 206 then calculates the estimated remaining useful life of the device 202 as the sum of the remaining time in the second modified early degradation region 14B plus the sum of the remaining times in the other regions 16, 18.

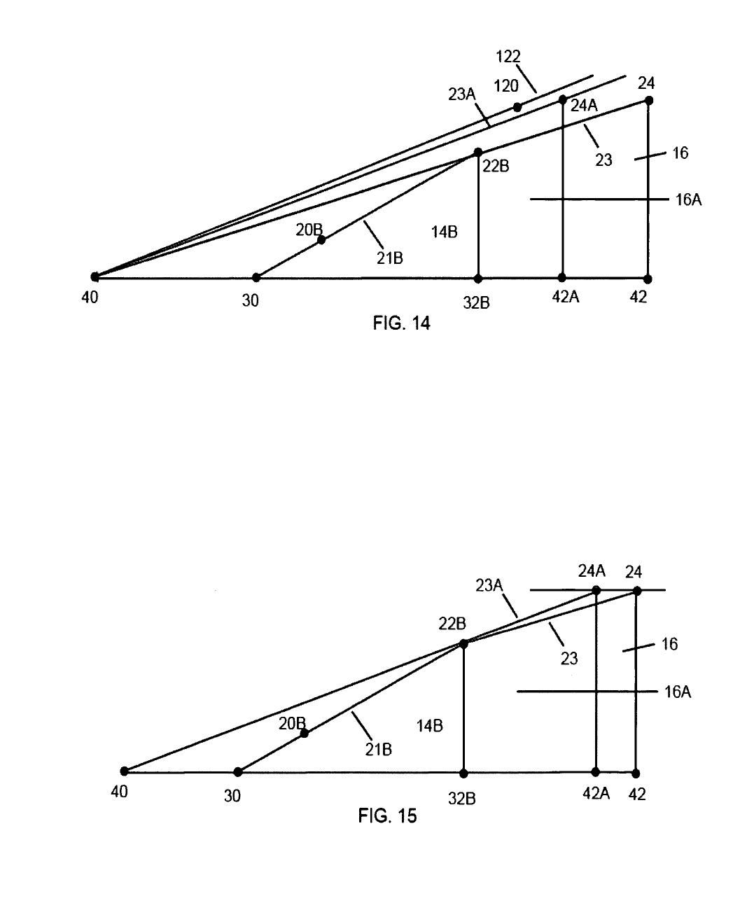

FIG. 14 shows the second modified early degradation region 14B of FIG. 13 and the mid-degradation region 16 of FIG. 5 in conjunction with an additional curve developed using a fifth data point 120. When the fifth data point 120 is received, the reasoner calculates the slope of a fifth data point line 122 that passes through the fifth data point 120 and the virtual origin point 40 of the mid-degradation region 16. The reasoner 206 then averages, with or without weighting, the slope of the fifth data point line 122 and the mid-degradation line segment 23 to produce a first modified mid-degradation line 23A. The third degradation point 24 is then shifted to coincide with the first modified mid-degradation line 23A, becoming the first modified third degradation point 24A occurring at an upper temporal boundary that is likewise shifted from point 42 to point 42A, which marks the temporal upper limit of a first modified mid-degradation region 16A.

Referring to FIG. 15, the reasoner 206 time-shifts the mid-degradation region 16A so that the first modified mid-degradation line 23A intersects the second modified second degradation point 22B, which causes the upper temporal boundary of point 42A of the first modified mid-degradation region 16A to likewise shift with respect to virtual origin point 30 of the second modified early degradation region 14B. The late degradation region 18 is time-shifted so that the upper temporal boundary of the first modified mid-degradation region 16A coincides with a lower temporal boundary of the late degradation region 18. The reasoner 206 then calculates the estimated remaining useful life of the device 202 as the sum the remaining time in the first modified mid-degradation region 16A plus the remaining time in late degradation region 18.

Referring to FIG. 15 and comparing that to FIG. 14, it is seen that a temporal length of the first modified mid-degradation region 16A has been adapted to the higher rate of degradation evidenced by the high vertical value of the fifth data point 120 and the relatively short distance horizontal distance between the first modified third degradation point 24A and the second modified second degradation point 22B; the measured degradation rate is higher than the degradation rate of the model.

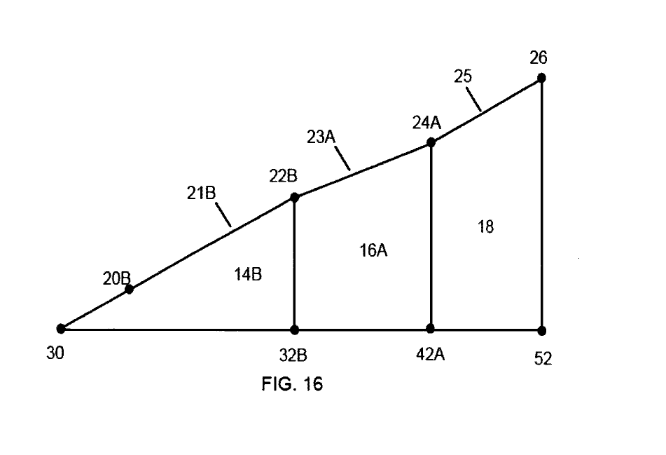

Referring to FIG. 16, the adaptation of the model is seen in the difference in size of the early degradation region 14 and the mid-degradation region 16 in FIG. 7 (before adaptation) and the second modified early degradation region 14B and the first modified mid-degradation region 16A in FIG. 15 (after adaptation). A similar adaptation of the model to current data may be performed for data points occurring in the remainder of the first modified mid-degradation region 16A and through the late degradation region 18. The reasoner 206 may stop recalculating the remaining useful life of the device 202 when either the device 202 fails (meaning the remaining useful life is null) or when the device 202 is replaced by a new device, for which the reasoner 206 may begin operating anew. Once the device 202 is replaced with a new device, the reasoner 206 may be programmed to predict remaining useful life based on the original fault-to-failure regression model regions 14, 16, 18 or based on the adapted fault-to-failure regression model regions 14B, 16A, 18.

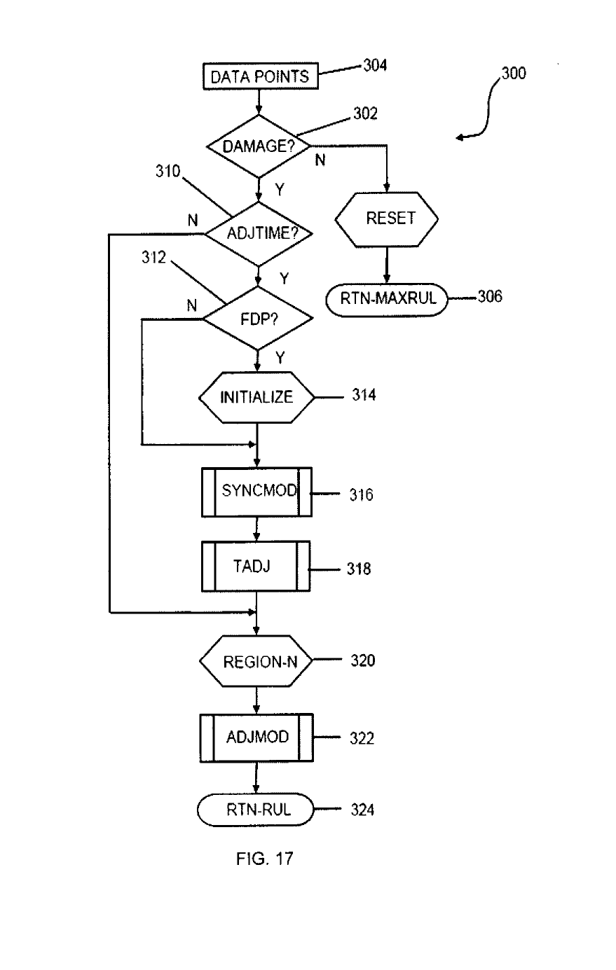

FIG. 17 is a flowchart 300 illustrating a method of providing the system 200 for predicting a remaining useful lifetime of a device 202 in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

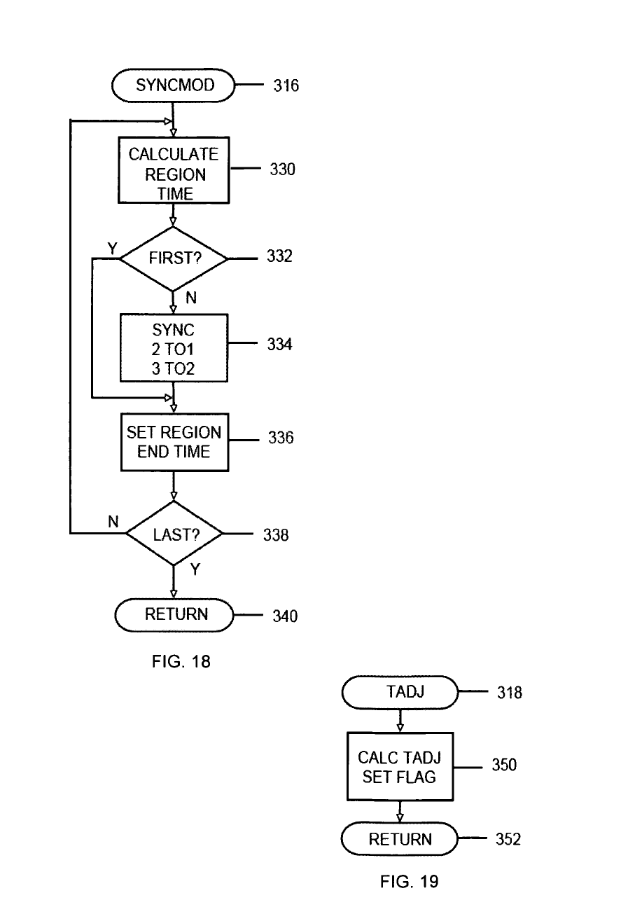

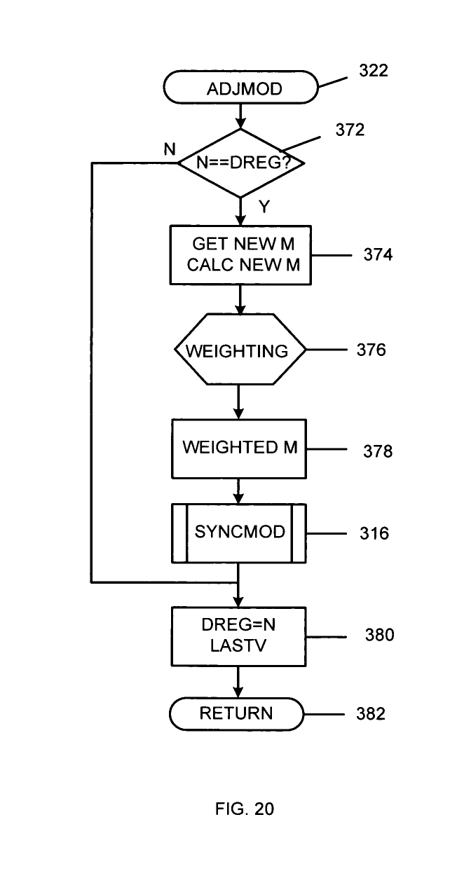

As is shown by block 302, the primary inputs to the reasoner 206 are data points 304 having coordinates, specifically the vertical measurands, V, and horizontal temporal values, T. If a data point 304 (V, T) is not in a region of damage, the reasoner 206 is returns to the caller of the reasoner (block 306) and a maximum remaining useful lifetime value is returned (block 306). As discussed in relation to the first data point 100 in the exemplary embodiment of the system 200, a data point is not in a region of damage if it is has a vertical measurand value below the vertical measurand value of the initial degradation point 20. If a data point is received having showing damage in one of the regions 14, 16, 18, the reasoner 206 determines whether the data point is on one of the degradation line segments 21, 23, 25 (block 310). If the received data point is on one of the degradation line segments 21, 23, 25, the model does not need to be adapted. If the received data point is not on one of the degradation line segments 21, 23, 25, the model needs to be adapted. If the model needs to be adapted, the reasoner 206 determines whether this is the first data point requiring model adaptation (block 312). If it is, the reasoner 206 and the model are initialized (block 314). The degradation regions 14, 16, 18 are synchronized (block 316) (see FIG. 18). The time system is adjusted to reflect the model time (block 318) (see FIG. 18). The system determines the region of damage (block 320). The model is adjusted (block 322) (see FIG. 20). The remaining useful life is calculated relative to the data point (324).

FIG. 18 is a flow chart for the system 316 of synchronizing the degradation regions 14, 16, 18. For each degradation region 14, 16, 18, the virtual time of the degradation region 14, 16, 18 is calculated (block 330). For the early degradation region 14, the calculated virtual time becomes the end of either a modified or unmodified early degradation, for example the first modified early degradation region 14A; the mid-degradation region 16 is shifted to abut an end of the first modified or unmodified early degradation region 14, for example the second modified early degradation region 14B; and the late modified or unmodified degradation region 18 is shifted to abut an end of the shifted mid-degradation region 16 (block 334). That step is skipped if the reasoner 206 is operating from the first data point with a measurand value above the measurand value of the initial degradation point 20 (block 332). The end point of each degradation region 14, 16, 18 is set (block 336). It is understood that degradation regions 14, 16 and 18 might include unmodified regions and/or modified regions. After all the regions are synchronized (block 338), the routine returns to the calling routine at the main flow chart 300 or the system 322 for adjusting the model time (block 340).

FIG. 19 is a flow chart of the method 318 for adjusting system time to reflect the model time for the adaptive reasoner. The difference between the system time and the virtual time of the end of the first modified early degradation region 14A is calculated and saved to be used to convert system time to a relative model time (350). The routine returns to the calling routine, at the main flow chart 300 (block 352).

FIG. 20 is a flow chart of the system 322 for adjusting the model time. The adaptive reasoner inputs for the system 322 include the vertical measurand of a current data point, identification of the current degradation region for the vertical measurand, and the relative model time. The system 322 determines whether the current data point is in a same region as that most recently modified (block 372). If not, some of the system 322 steps may be avoided, as shown in FIG. 20. If the current data point is in a most recently modified region and it is at least the second data point with a vertical measurand greater than the initial degradation point 20, a new slope is calculated (block 374). A weighting value may be applied to the previous slope (block 376) and used to calculate a weighted new degradation region line segment (378). The model regions are synchronized (block 316). The new degradation line segment and the modified degradation regions are committed to memory (block 380). The routine returns to the calling routine, at the main flow chart 300 (block 382).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for predicting a remaining useful lifetime of a device and revising the prediction during the lifetime of the device, said system comprising:
a defining signature comprising at least one characteristic of the device, said defining signature changing as said device accumulates damage through a period of useful lifetime in a damaged state;
a sensor in communication with said device, said sensor sensing at least one characteristic of said characteristics of said defining signature as said device accumulates damage through said period of useful lifetime;
a predictive curve with said defining signature mapped over an anticipated useful lifetime of said device in said damaged state, whereby said predictive curve provides a preliminary prediction of said remaining useful lifetime of said device in said damaged state; and
a reasoner in communication with the sensor, said reasoner modifying the predictive curve relative to the sensed at least one characteristic of said at least one characteristic of said defining signature, thereby providing a normalization of said defining signature to said predictive curve.

2. The system of claim 1, further comprising an indicator in communication with the predictive curve, wherein the indicator initiates when the device has reached a predetermined level of accumulated damage, providing an indication that said device is operating in a new state of damage and an accompanying indication of said remaining useful lifetime.

3. The system of claim 1, further comprising a device memory in communication with the sensor, said device memory storing information sensed by the sensor.

4. The system of claim 1, wherein the predictive curve is divided into a plurality of measurand-defined curve sections.

5. The system of claim 1, wherein the reasoner modifies a slope of only a contemporary temporally divided curve section of a plurality of temporally divided curve sections based on a sensed defining signature event.

6. The system of claim 5, wherein the reasoner time-shifts all of said plurality of temporally divided curve sections temporally subsequent to the contemporary temporally divided curve section.

7. (canceled)

8. The system of claim 1, further comprising a plurality of devices, wherein the reasoner modifies the predictive curved relative to the sensed at least one characteristic of said at least one characteristic of said defining signature for each of the plurality of devices.

9. A method for predicting a remaining useful lifetime of a device in a damaged state and revising the prediction during the remaining lifetime of the device in said damaged state, said method comprising the steps of:
sensing at least one characteristic of a defining signature of said device over time, said at least one characteristic changing as said device accumulates damage through a period of a useful lifetime;
modifying a predictive curve relative to the sensed at least one characteristics over time, said predictive curve having said defining signature mapped over an anticipated remaining useful lifetime of said device in said damaged state, whereby said predictive curve provides a prediction of said remaining useful lifetime of said device in said damaged state.

10. The method of claim 9, further comprising indicating imminent device failure when the device in said damaged state has a predetermined period of time remaining on the prediction of said remaining useful lifetime.

11. The method of claim 9, further comprising storing characteristics sensed by the sensor.

12. A method for predicting a remaining useful lifetime of a device and revising the prediction during the lifetime of the device in a damaged state, said method comprising the steps of:
sensing at least one characteristic of a defining signature of said device over time, said defining signature changing as said device accumulates further damage through a useful lifetime in said damaged state;
defining an attainable value for the defining signature, whereby the attainable value is indicative of damage to the device; and
modifying a predictive curve relative to the sensed at least one characteristic of said defining signature in conjunction with the sensed at least one characteristic of said defining signature achieving a value greater than the attainable value, whereby said predictive curve provides a prediction of said remaining useful lifetime of said device in said damaged state.

13. The method of claim 12, further comprising indicating imminent device failure when the device has a predetermined period of time remaining on the prediction of said remaining useful lifetime.

14. The method of claim 12, further comprising storing characteristics sensed by the sensor.

15. The method of claim 12, further comprising dividing the predictive curve into a plurality of sections, wherein the step of modifying the predictive curve further comprises modifying a size of a section concurrent with the sensed at least one characteristic characteristics of the defining signature and shifting subsequent sections relative to the size modification of the section concurrent with the sensed at least one characteristic of said defining signature.

16. The method of claim 15, wherein the plurality of sections of the predictive curve are divided into measurand-defined sections.

17. The method of claim 15 wherein the step of modifying a size of a section concurrent with the sensed at least one characteristic of the defining signature further comprises modifying a temporal width of the section, wherein an average measurand height of the section remains unmodified.

18. The method of claim 15, wherein each section has a maximum measurand height and a section ceases to be modified when a value of the defining signature exceeds the maximum measurand height of that section.

19. The method of claim 12, wherein the predictive curve is linearized.
